(19) United States
(12) Patent Application Publication
(10) Pub. No.: US 2026/0210721 A1
(43) Pub. Date: Jul. 23, 2026

(54) FIRST NODE, SECOND NODE AND METHODS PERFORMED THEREBY FOR HANDLING MAPPING INFORMATION ENABLING TO MAP A SPACE

(71) Applicant: Telefonaktiebolaget LM Ericsson (publ), Stockholm (SE)

(72) Inventors: Gerasimos DAMIGOS, Luleå (SE); Tore LINDGREN, Luleå (SE); Sara SANDBERG, Luleå (SE); George NIKOLAKOPOULOS, Luleå (SE); Nikolaos STATHOULOPOULOS, Luleå (SE)

(21) Appl. No.: 19/136,128

(22) PCT Filed: May 12, 2023
(86) PCT No.: PCT/EP2023/062812

§ 371 Date: Jun. 5, 2025

(30) Foreign Application Priority Data
Mar. 31, 2023 (GR) 20230100277

(51) Int. Cl. G01C 21/20; G01C 21/00

(52) U.S. Cl. CPC G01C 21/20; G01C 21/3841; G01C 21/3885

(57) ABSTRACT

A method for handling a mapping information enabling to map a space. A first node obtains first mapping information from a first space. The first node also obtains other information indicating one or more indicators of performance of the communications system. The first node then adapts one or more first characteristics of the first mapping information for transmission to a second node. The adapting is based on the obtained other information. The adapting is performed so that an ability of the adapted mapping information is retained within a time constraint. The ability is to be at least one of: i) merged with second mapping information from a second space at least partially overlapping with the first space, and ii) used for localization. The first node then sends the adapted information to the second node.

### TECHNICAL FIELD

The present disclosure also relates generally to a first node and methods performed thereby for handling mapping information enabling to map a space. The present disclosure further relates generally to a second node and methods performed thereby for handling mapping information enabling to map the space. The present disclosure further relates generally to computer programs and computer-readable storage mediums, having stored thereon the computer programs to carry out these methods.

### BACKGROUND

Communications systems may comprise one or more nodes. A node may comprise one or more processors which, together with computer program code may perform different functions and actions, a memory, a receiving port and a sending port. A node may be, for example, a server. Nodes may perform their functions entirely on the cloud.

Communications systems may comprise a telecommunications network, wherein the nodes may operate. The telecommunications network may cover a geographical area which may be divided into cell areas, each cell area being served by a type of node, a network node in the Radio Access Network (RAN), radio network node or Transmission Point (TP), for example, an access node such as a Base Station (BS), e.g., a Radio Base Station (RBS), which sometimes may be referred to as e.g., gNB, evolved Node B (“eNB”), “eNodeB”, “NodeB”, “B node”, or Base Transceiver Station (BTS), depending on the technology and terminology used. The base stations may be of different classes such as e.g., Wide Area Base Stations, Medium Range Base Stations, Local Area Base Stations and Home Base Stations, based on transmission power and thereby also cell size. A cell may be understood to be the geographical area where radio coverage may be provided by the base station at a base station site. One base station, situated on the base station site, may serve one or several cells. Further, each base station may support one or several communication technologies. The telecommunications network may also comprise network nodes which may serve receiving nodes, such as user equipments, with serving beams.

In the course of operations of the telecommunications network, data may be collected on which may enable to monitor and manage different functions.

The advent of for example, the Internet of Things (IoT) has exponentially increased the amount of data to be monitored. The availability of large amounts of data, such as those collected for example, from IoT devices, may be understood to enable the possibility of analysing such data to make predictions on events, with a high predictive power. To make predictions on events may be understood to refer to building mathematical models that may fit those data, which mathematical models may then be used to make predictions for such events. Within this context, machine learning models may be used to analyze the data collected, and enable an improved management of the operation of the telecommunications network.

### Mapping and Localization

Functions for which data may be collected in a communications system may be mapping and localization.

Mapping may be understood to refer to a task of generating a virtual copy of a real-life physical environment, a map, that may be used by localization algorithms for navigation and to localize objects of interest. Mapping tasks may be generally accomplished by autonomous agents moving in the environment to be mapped. An agent may be understood to refer to hardware and/or software, e.g., to a device, that may be designed to operate, capture/map the surrounding environment, respond to changes in the environment based on a set of rules, algorithms and other permitted actions, so that a desired mission may be completed. A mission may be, e.g., as large and well defined as a search and rescue mission or may even be an XR application. Agents within this mapping context may be e.g., automated guided vehicles (AGVs) moving on a factory floor, mining machines moving in underground tunnels, drones operating on a joint mission, etc. In many applications, such as self-driving cars and robotics, multiple sensors may be used to perceive the environment, and the data from these sensors may be processed, e.g., fused, in order to create a consistent map of the environment, providing better situational awareness such that all agents may refer to a common global map. That is, a map covering the whole space in which the mission may be performed.

Localization may be understood as a task of estimating the position and orientation of an agent based on sensor readings and map data.

### Map merging

A shared space may be described by multiple agents. That is, autonomous robots may collaborate in mapping a given environment. Each robot may bear one or more sensors which may collect data from the environment, which data may then be processed to generate a map. Each of the robots may generate its own map with the data collected by its own set of sensors. This may be referred to as a local map. The local maps of the different robots working collaboratively in a mapping task, which may be performed in the context of a mission, may be combined, or merged, to form a so-called, global map of the environment. Combining the local maps of different robots may be understood to aid in making the mapping task more efficient, that is, accomplishing the mapping of a larger area in a shorter amount of time.

Real-time map merging may be understood to refer to a process of combining multiple local maps, created by different sensors or from different sources, into a single global map in real-time.

The process of real-time map merging may be understood to typically involve several steps. The first step may be understood to be to identify the common features or correspondences between the maps. The next may be understood to be the map registration, which may be understood as the process of aligning the different local maps, based on the computed correspondences, so that they may be in the same coordinate frame. Finally, after the alignment, the maps may be merged or fused into a single global map. Fusion may be understood as combining maps that may represent different aspects of the same environment. For example, one map may represent the geometric layout of the environment, while another map may represent the location and identity of objects within that environment. On the other hand, map merging may be used to combine maps that may represent different parts of the same environment.

As map merging is an active field of research, several algorithms have been proposed for the aforementioned steps, such as pose-graph based optimization [1], reinforcement learning based methods [2], etc.

Real-time map merging may be understood to be particularly relevant in situations where an agent may benefit from getting map information from other agents moving in overlapping areas. It may be understood to be important to highlight the difference between the term real-time and the post processing techniques of captured sensor data that may be commonly used in state-of-the-art solutions. For multiagent scenarios, most of the existing applications may be understood to refer to techniques that may consider post processing of captured sensor data. Considering this, a real-time application may be understood to refer to an application that may use data from additional agents during a mission without impeding or delaying the mission. Within the context of this disclosure, a mission may be understood as several agents working collaboratively to solve a task that may require mapping.

In order to perform real-time map merging, it may be understood to be important to have sensors that may provide accurate and reliable data, and to have fast and efficient algorithms that may process and fuse the data in real-time. Another relevant aspect of such a framework may refer to the communication between the multiple agents.

Often, the uplink communication may include parts of a map to be transmitted to a centralized unit or another agent. Similarly, a centralized unit may be understood to be responsible for the merging of the maps and the distribution of the information back to the corresponding agents, in the downlink direction.

In order to facilitate communication between the agents collaborating in a mapping task, compression of mapping information may be used when communicating such information. In existing literature there may be many different ways of compressing map information/three Dimensional (3D) Maps.

One compression method may be Octree Compression. This technique may partition the 3D space into a hierarchical structure of cubes, known as an octree. The octree structure may enable efficient compression by only storing the necessary data points in the regions of interest. The compression ratio may depend on the depth of the octree, which may determine the size of the cubes.

Another compression method may be performed by eliminating points that may be less important. One example of such a method may be the Douglas-Peucker algorithm, which may remove points that may not contribute much to the overall shape.

A further compression method may be Prediction. Predictive techniques may use the relationship between nearby points to reduce the amount of data needed to represent the point cloud. The point cloud may be understood as a set of points in an N-dimensional 3(ND) coordinate system, where each point may describe an ND coordinate which may have value or sensor reading associated to it, e.g., color, temperature, etc. A commonly known coordinate system may refer to the cartesian coordinate system. One example may be the Differential Pulse Code Modulation (DPCM) technique, which may store only the differences between neighboring points.

Another compression method may be Mesh-based Compression. This technique may represent the point cloud as a mesh of connected triangles and may compress the mesh by reducing the number of triangles. There may be various mesh simplification algorithms that may be used, such as edge-collapse and vertex-clustering.

An additional compression method may be Transform-based Compression. This technique may convert the 3D point cloud into a different representation that may be more amenable to compression. For example, the Discrete Cosine Transform (DCT) may be applied to transform the 3D point cloud into the frequency domain, where the high-frequency components may be discarded or quantized.

Yet another compression method may be Progressive Transmission. This technique may send a compressed version of the point cloud over a network in a series of passes, each with increasing levels of detail. This may allow the receiver to start rendering the point cloud while more data may be being transmitted, providing a more responsive user experience.

In spite of the benefits afforded by the compression algorithms just described, existing mapping methods may still experience communication challenges between the agents and the centralized server, and among the different agents. A multi-agent large scale approach is today only possible with extended offline processing. Communication loss, or degraded connectivity resulting in extensive delays and dropped data packets will make such a framework fail and may also affect the individual mission of each agent in a mapping task.

### SUMMARY

As part of the development of embodiments herein, one or more challenges with the existing technology will first be identified and discussed.

If the map information from one agent is not timely transmitted to the centralized unit that merges map information from several agents, the updated map information that another agent receives will not contain the latest available information, that is, the agents will not be synchronized. In the same way, if the map information from the centralized unit is not received in time, the latest received map information will not contain the latest available information.

This may be understood to become significantly important in situations that consider safety. A characteristic example of where the aforesaid communication may be particularly relevant, may be in the context of a search and rescue situation. The ability of merging information, that is, merging the maps, in real-time, e.g., during the mission, may significantly affect the success of the mission.

Less determining in terms of safety, but yet still impactful, may be scenarios where it may be desired to perform frequent mapping of ports or other significantly large industrial sites by deployments of robots to benefit future planning. However, frequent mapping tasks in such scenarios may increase disruption of site operations and decrease production by its physical presence on the ground and/or interfering communications.

In view of the foregoing, it may be desirable to dynamically adapt the transmission of mapping information based on connectivity conditions and limitations. Such information may include map instances transmitted from the individual agents to a centralized unit and information that may be necessary or relevant to complete the merging operation.

For modern robotic platforms to carry out reliable autonomous missions they may need to be outfitted with a variety of sensors resulting in the output of a large amount of data. The speed at which data may be generated onboard the robotic platform, Extended Reality Head Mounted Displays (XR HMDs), etc., may be often higher than the throughput that the communication system may provide. Each agent may therefore need to regulate data communication and avoid congesting the network. However, a solution that considers the real-time connectivity and communication conditions while doing real-time map merging does not exist.

In accordance with this, it is an object of embodiments herein to improve the handling of mapping information enabling to map a space.

According to a first aspect of embodiments herein, the object is achieved by a computer-implemented method, performed by a first node. The method is for handling mapping information enabling to map a space. The first node operates in a communications system. The first node obtains first mapping information from a first space derived from one or more first sensors. The first node also obtains other information indicating one or more indicators of performance of the communications system. The first node then adapts one or more first characteristics of the first mapping information for transmission to a second node operating in the communications system. The adapting is based on the obtained other information. The adapting is performed so that an ability of the adapted first mapping information is retained within a time constraint. The ability is to be at least one of: i) merged with second mapping information from a second space at least partially overlapping with the first space; the second mapping information is derived from one or more second sensors, and ii) used for localization. The first node then sends the adapted first mapping information to the second node.

According to a second aspect of embodiments herein, the object is achieved by a computer-implemented method, performed by a second node. The method is for handling the mapping information enabling to map the space. The second node operates in a communications system. The second node receives, from the first node operating in the communications system, the adapted first mapping information. The adapted first mapping information is from the first space derived from the one or more first sensors. The one or more first characteristics of the first mapping information for transmission from the first node are adapted so that the ability of the adapted first mapping information is retained within the time constraint. The ability is to be at least one of: i) merged with the second mapping information from the second space at least partially overlapping with the first space; the second mapping information being derived from the one or more second sensors, and ii) used for localization. The second node then uses the received adapted first mapping information within the time constraint, based on the one or more first characteristics, to at least one of: i) merge the adapted first mapping information with the second mapping information, and ii) localization.

According to a third aspect of embodiments herein, the object is achieved by a computer-implemented method, performed by the first node. The first node is for handling the mapping information enabling to map the space. The first node is configured to operate in the communications system. The first node is further configured to obtain the first mapping information from the first space configured to be derived from the one or more first sensors. The first node also configured to obtain the other information configured to indicate the one or more indicators of performance of the communications system. The first node is also configured to adapt the one or more first characteristics of the first mapping information for transmission to the second node configured to operate in the communications system. The adapting is configured to be based on the other information configured to be obtained. The adapting is configured to be performed so that the ability of the adapted first mapping information is retained within the time constraint. The ability is configured to be, to be at least one of: i) merged with the second mapping information from the second space at least partially overlapping with the first space; the second mapping information is configured to be derived from the one or more second sensors 142, and ii) used for localization. The first node is additionally configured to send the first mapping information configured to be adapted to the second node.

According to a fourth aspect of embodiments herein, the object is achieved by the second node. The second node is for handling the mapping information enabling to map the space. The second node operates in the communications system. The second node receives, from the first node configured to operate in the communications system, the adapted first mapping information from the first space configured to be derived from one or more first sensors. The one or more first characteristics of the first mapping information for transmission from the first node are configured to be adapted so that the ability of the adapted first mapping information is retained within the time constraint. The ability is configured to be, to be at least one of: i) merged with the second mapping information from the second space at least partially overlapping with the first space; the second mapping information being configured to be derived from the one or more second sensors, and ii) used for localization. The second node is also configured to use the adapted first mapping information configured to be received within the time constraint, based on the one or more first characteristics, to at least one of: i) merge the adapted first mapping information with the second mapping information, and ii) localization.

According to a fifth aspect of embodiments herein, the object is achieved by a computer program, comprising instructions which, when executed on at least one processor, cause the at least one processor to carry out the method performed by the first node.

According to a sixth aspect of embodiments herein, the object is achieved by a computer-readable storage medium, having stored thereon the computer program, comprising instructions which, when executed on at least one processor, cause the at least one processor to carry out the method performed by the first node.

According to a seventh aspect of embodiments herein, the object is achieved by a computer program, comprising instructions which, when executed on at least one processor, cause the at least one processor to carry out the method performed by the second node.

According to an eighth aspect of embodiments herein, the object is achieved by a computer-readable storage medium, having stored thereon the computer program, comprising instructions which, when executed on at least one processor, cause the at least one processor to carry out the method performed by the second node.

By obtaining the first mapping information, the first node may enable to eventually accomplish that the mapping of the space may be successfully performed.

By obtaining the other information, the first node may be enabled to determine how the performance of the communications system may be, and in accordance with such determination, consider applying a control mechanism that may account for variations the link throughput of the communication system, e.g. as a result from variations in channel quality, cell load, interference, etc., to regulate transmission of the first mapping information.

If the map information from one agent is not timely transmitted to the centralized unit that may merge the mapping information from several agents, the updated map information that another agent receives may not contain the latest available information, that is, the agents may not be synchronized. In the same way, if the map information from the centralized unit may not be received in time, the latest received map information may not contain the latest available information.

By adapting the one or more first characteristics of the first mapping information for transmission to the second node, the first node may be enabled to dynamically control the first mapping information, e.g., the size of each map instance, order of map instances, rate of map instances to transmit, based on available communication KPIs.

By then sending the adapted first mapping information to the second node, the first node may enable usage of the first mapping information by the second node, so that a successful mapping mission may be ensured within the time constraint, e.g., for mapping in real time or for synchronization with other agents during a mapping mission. This may advantageously enable, for example, that an operator may have access to the merged map and awareness of the area instead of extreme delays or loss of a large fraction of the mapping information.

By the second node receiving the adapted first mapping information from the first space, the second node may then be enabled to use the adapted first mapping information to merge it with the second mapping information and/or for localization, while it may be ensured that the successful mapping mission may be ensured within the time constraint.

### BRIEF DESCRIPTION OF THE DRAWINGS

Examples of embodiments herein are described in more detail with reference to the accompanying drawings, according to the following description.

FIG. 1 is a schematic diagram illustrating a non-limiting example of a communications system, according to embodiments herein.

FIG. 2 is a flowchart depicting embodiments of a method in a first node, according to embodiments herein.

FIG. 3 is a flowchart depicting embodiments of a method in a second node, according to embodiments herein.

FIG. 4 is a flowchart depicting embodiments of a method performed according to embodiments herein.

FIG. 5 is a schematic block diagram illustrating two non-limiting examples, a) and b), of a first node, according to embodiments herein.

FIG. 6 is a schematic block diagram illustrating two non-limiting examples, a) and b), of a second node, according to embodiments herein.

### DETAILED DESCRIPTION

Certain aspects of the present disclosure and their embodiments address one or more of the issues with the existing methods discussed in the summary section and provide solutions to the challenges discussed.

Embodiments herein may be understood to relate in general to control of information transmission for real-time map merging.

As a summarized overview, embodiments herein may be understood to relate to the problem of multi-agent, centralized, real-time map-merging. Embodiments herein may be understood to introduce a communication-aware control function that may regulate the transmission of map information, while taking communication indicators, e.g., Key Performance Indicators (KPIs), such as the network load, into account. The transmission of the map information may be regulated e.g., through the size and/or resolution of the map instances, the rate with which map instances may be transmitted, and the order in which map instances may be transmitted, e.g., based on importance.

Embodiments herein may be applicable for any application that may use simultaneous localization and mapping (SLAM) with a common map. Such applications may be found in e.g., Extended Reality (XR), robotics, automotive, etc. Particular embodiments herein may be performed by a device performing SLAM, e.g., an XR head mounted display (HMD) or an Automated Guided Vehicle (AGV), where real-time multi-agent map merging may be desired. Embodiments herein may be advantageously used to frequently map and monitor the spatial arrangement of city regions, e.g., smart cities scenario.

The embodiments will now be described more fully hereinafter with reference to the accompanying drawings, in which examples are shown. In this section, embodiments herein are illustrated by exemplary embodiments. It should be noted that these embodiments are not mutually exclusive. Components from one embodiment or example may be tacitly assumed to be present in another embodiment or example and it will be obvious to a person skilled in the art how those components may be used in the other exemplary embodiments. All possible combinations are not described to simplify the description.

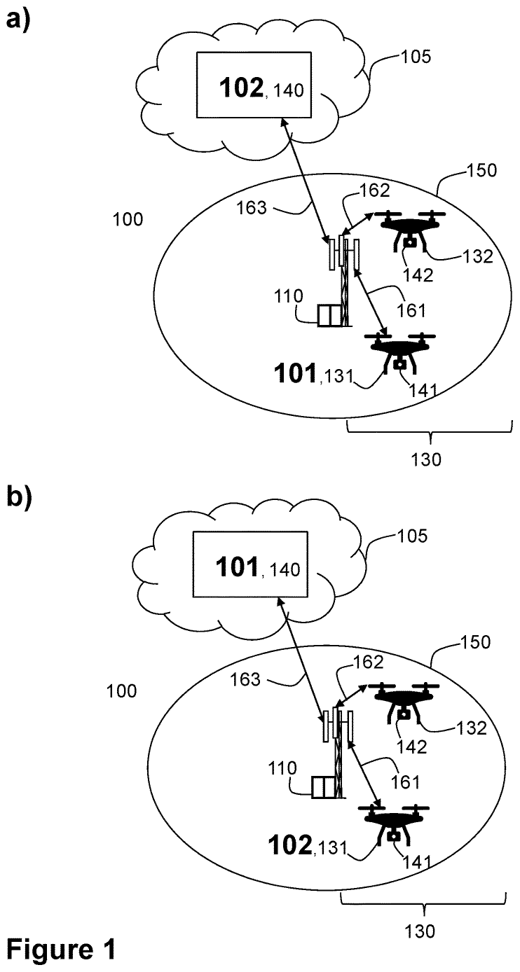

FIG. 1 depicts two non-limiting examples, in panels “a” and “b”, respectively, of a communications system 100, in which embodiments herein may be implemented. The communications system 100 may be understood to be a computer network in a telecommunications network, sometimes also referred to as a cellular radio system, cellular network or wireless communications system. In some examples, the communications system 100 may for example be a network such as 5G system, or a newer system supporting similar functionality. The communications system 100 may additionally or alternatively support other technologies, such as, for example, a Fourth Generation (4G) system, such as a Long-Term Evolution (LTE) network, e.g., LTE Frequency Division Duplex (FDD), LTE Time Division Duplex (TDD), LTE Half-Duplex Frequency Division Duplex (HD-FDD), LTE operating in an unlicensed band, Wideband Code Division Multiple Access (WCDMA), Universal Terrestrial Radio Access (UTRA) TDD, Global System for Mobile communications (GSM) network, GSM/Enhanced Data Rate for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, Wireless Local Area Network/s (WLAN) or WiFi network/s, Worldwide Interoperability for Microwave Access (WiMax), IEEE 802.15.4-based low-power short-range networks such as IPv6 over Low-Power Wireless Personal Area Networks (6LowPAN), Zigbee, Z-Wave, Bluetooth Low Energy (BLE), or any cellular network or system. The communications system 100 may for example support a Low Power Wide Area Network (LPWAN). LPWAN technologies may comprise Long Range physical layer protocol (LoRa), Haystack, SigFox, LTE-M, and Narrow-Band IoT (NB-IoT).

Although terminology from Long Term Evolution (LTE)/5G has been used in this disclosure to exemplify the embodiments herein, this should not be seen as limiting the scope of the embodiments herein to only the aforementioned system. Other wireless systems that support similar or equivalent functionality may also benefit from exploiting the ideas covered within this disclosure. In future telecommunication networks, e.g., in the sixth generation (6G), the terms used herein may need to be reinterpreted in view of possible terminology changes in future technologies.

The communications system 100 may comprises a plurality of nodes, whereof a first node 101 and a second node 102 are depicted in FIG. 1.

Any of the first node 101 and the second node 102 may be understood, respectively, as a first computer system and a second computer system. In some examples, any of the first node 101 and the second node 102 may be implemented as a standalone server in e.g., a host computer in the cloud 105. Any of the first node 101 and the second node 102 may in some examples be a distributed node or distributed server, with some of their respective functions being implemented locally, e.g., by a client manager, and some of its functions implemented in the cloud 105, by e.g., a server manager. Yet in other examples, any of the first node 101 and the second node 102 may also be implemented as processing resources in a server farm.

The first node 101 may be understood to be a node having a capability to obtain mapping information and transmit the mapping information to another node, e.g., the second node 102. That is, the first node 101, in embodiments herein, may be understood to refer to a node sharing mapping information with the second node 102. In the uplink, the mapping information may be a local map. This may apply also in the sidelink for some embodiments. In the downlink, the mapping information may be a global map. This may apply also in the sidelink for some embodiments.

The second node 102 may be understood to be a node having a capability to receive mapping information from another node, e.g., the first node 101, and use the mapping information, e.g., to perform a mapping or a localization task. That is, the second node 102, in embodiments herein, may be understood to refer to a node receiving mapping information from the first node 101.

Transmission and/or reception may be performed directly or e.g., via a network node 110, which will be described later.

In some examples, such as that depicted in panel a) of FIG. 1, the first node 101 may be an agent, e.g., any device of a plurality of devices 130, e.g., a first device 131, or any of one or more devices 132, such as a robot or an Unmanned Aerial Vehicle (UAV), and the second node 102 may be a core network node 140, e.g., a central unit/server capable of merging the maps created separately by the first device 131 and the one or more devices 132. The mapping information may in such examples be sent in the uplink. The server may be located either separately, in one of the devices of the plurality of devices 130, or in the core network, as, e.g., an edge cloud. The central unit/server may be also responsible for distributing the merged information back to the agents.

The first device 131 may bear one or more first sensors 141. Any of the one or more second devices 132 may bear, respectively, one or more second sensors 142. A sensor in this context may be any device capable of collecting information susceptible to be used for mapping purposes, such as, e.g., lidar, a camera, an ultrasound device, a radar, RGB camera, RGB-depth camera, sonar, time-of-flight sensors, infrared, etc.

In some examples, such as that depicted in panel b) of FIG. 1, the first node 101 may be the core network node 140, e.g., managing a centralized unit responsible for merging mapping information from the plurality of agents 131, 132, and the second node 102 may be the agent, e.g., the first device 131 or any of the one or more second devices 132, e.g., a robot or a UAV. The mapping information may in such examples be sent in the downlink.

Yet in other examples not depicted in FIG. 1, the first node 101 and the second node 102 may both be devices of the plurality of devices 130.

In particular embodiments herein, any of the first node 101 and the second node 102 may be understood to be nodes having a capability to perform SLAM.

In some non-limiting examples, the communications system 100 may comprise one or more network nodes, whereof a network node 110 is depicted in FIG. 1. The network node 110 may be a radio network node, such as a base station or Transmission Point (TP), or any other network unit capable to serve a wireless device or a machine type node in the communications system 100. The network node 110 may be e.g., a 5G gNB, a 4G eNB, or a radio network node in an alternative 5G radio access technology, e.g., fixed or WiFi. The network node 110 may be e.g., a Wide Area Base Station, Medium Range Base Station, Local Area Base Station and Home Base Station, based on transmission power and thereby also coverage size. The network node 110 may be a stationary relay node or a mobile relay node. The network node 110 may support one or several communication technologies, and its name may depend on the technology and terminology used. The network node 110 may be directly connected to one or more networks and/or one or more core networks.

The communications system 100 may cover a geographical area, which in some embodiments may be divided into cell areas, wherein each cell area may be served by a network node, although, one network node may serve one or several cells. The network node 110 in FIG. 1 serves a cell 150.

The network node 110 may be of different classes, such as, e.g., macro eNodeB, home eNodeB or pico base station, based on transmission power and thereby also cell size. In some examples, the network node 110 may serve receiving nodes with serving beams.

The communications system 100 may further comprise the plurality of devices 130 comprising the first device 131 and the one or more second devices 132. Any of the first device 131 and the one or more second devices 132 may be also known as e.g., user equipment (UE), a wireless device, mobile terminal, wireless terminal and/or mobile station, mobile telephone, cellular telephone, or laptop with wireless capability, or a Customer Premises Equipment (CPE), just to mention some further examples. Any of the first device 131 and the one or more second devices 132 in the present context may be, for example, portable, pocket-storable, hand-held, computer-comprised, or a vehicle-mounted mobile device, enabled to communicate voice and/or data, via a RAN, with another entity, such as a server, a laptop, a Personal Digital Assistant (PDA), or a tablet computer, sometimes referred to as a tablet with wireless capability, or simply tablet, a sensor, a Machine-to-Machine (M2M) device, a device equipped with a wireless interface, such as a printer or a file storage device, modem, Laptop Embedded Equipped (LEE), Laptop Mounted Equipment (LME), Universal Serial Bus (USB) dongles or any other radio network unit capable of communicating over a radio link in the communications system 100. Any of the one or more devices 130 may be wireless, i.e., it may be enabled to communicate wirelessly in the communications system 100 and, in some particular examples, may be able support beamforming transmission. The communication may be performed e.g., between two devices, between a device and a radio network node, and/or between a device and a server. The communication may be performed e.g., via a RAN and possibly one or more core networks, comprised, respectively, within the communications system 100. In particular embodiments, any of the first device 131 and the one or more second devices 132 may be a robotic platform, XR HMD, AGV, UAV etc. In particular examples, any of the first device 131 and the one or more second devices 132 may be mobile.

Any of the first device 131 and the one or more second devices 132 may be capable of mapping the immediate surroundings using onboard sensors. The first device 131 and the one or more second devices 132 may be present in an area that is to be mapped. The maps created by the first device 131 and the one or more second devices 132 may be partially overlapping.

In yet further particular embodiments, any of the first device 131 and the one or more second devices 132 may have a capability to perform SLAM.

In FIG. 1, the one or more second devices 132 comprise a single device. It may be understood however, that this is for illustration purposes only, and that the one or more second devices 132 may comprise more devices.

The first device 131 and the one or more second devices 132 may be served by the network node 110.

The first device 131 may communicate with the network node 110 over a first link 161. Any of the one or more second devices 132 may communicate with the network node 110 over a respective second link 162. The core network node 140 may communicate with the network node 110 over a third link 163.

Any of the links just described may be, e.g., a radio link or a wired link, and may be a direct link or it may go via one or more computer systems or one or more core networks in the communications system 100, or it may go via an optional intermediate network. The intermediate network may be one of, or a combination of more than one of, a public, private or hosted network; the intermediate network, if any, may be a backbone network or the Internet, which is not shown in FIG. 1.

In general, the usage of “first”, “second” and/or “third” herein may be understood to be an arbitrary way to denote different elements or entities, and may be understood to not confer a cumulative or chronological character to the nouns they modify.

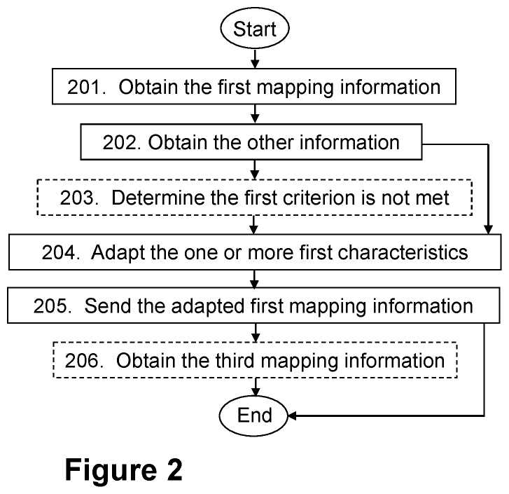

Embodiments of a computer-implemented method, performed by the first node 101, will now be described with reference to the flowchart depicted in FIG. 2. The method may be understood to be for handling mapping information enabling to map a space. The first node 101 operates in the communications system 100.

The method may comprise the actions described below. In some embodiments all the actions may be performed. In some embodiments some of the actions may be performed. In FIG. 2, optional actions are indicated with a dashed box. One or more embodiments may be combined, where applicable. All possible combinations are not described to simplify the description. It should be noted that the examples herein are not mutually exclusive. Components from one example or embodiment may be tacitly assumed to be present in another example or embodiment and it will be obvious to a person skilled in the art how those components may be used in the other examples or embodiments.

### Action 201

In this Action 201, the first node 101 may obtain first mapping information from a first space. The first mapping information may be derived from one or more first sensors 141, e.g., the one or more first sensors 141 borne by the first device 131, and/or the one or more second sensors 142 borne by the one or more second sensors 142.

The space may be, e.g., an area on a factory floor. The first space may be understood to be the same as the space, or a part of the space, e.g., that part of the space covered by the one or more first sensors 141.

Mapping information may be understood as any information that may characterize a constructed map slice, instance or part that may be used for object localization. Mapping information may be produced by a mapping algorithm, e.g., SLAM. Raw sensor data, such as a video stream, may be understood to not be mapping information, as it may be understood to not have been produced by a mapping algorithm and may not be used for localization without further processing. The content of the first mapping information may vary depending on whether the first node 101 may be one of the plurality of devices 130, e.g., the first device 131, and may then intend to send the first mapping information in the uplink, or sidelink, or, whether the first node 101 may be the node in charge of merging the mapping information provided by devices form the plurality of devices 130, e.g., the centralized server, and may then intend to send the first mapping information in the downlink, or sidelink, in the event the map merging may be performed by one of the devices in the plurality of devices 130.

In a first group of examples wherein the first node 101 may be one of the plurality of devices 130, e.g., the first device 131, the first mapping information may comprise e.g., all information that may characterize a locally, in an agent, constructed map slice/instance/part, e.g., a subset of the entire local map constructed by the first device 131. In this first group of examples, the first mapping information may then be intended to be sent to the second node 102 in the uplink or sidelink, so that it may be merged with the mapping information from the one or more second devices 132.

In a second group of examples wherein the first node 101 may be the node in charge of merging the mapping information provided by devices from the plurality of devices 130, e.g., the centralized server or one of the devices in the plurality of devices 130, the first mapping information may be e.g., all information that may characterize a globally constructed map slice/instance/part, a subset of the entire global map. In this second group of examples, the first mapping information may be intended to be sent to the second node 102 in the downlink or sidelink, so that it may be distributed back with the plurality of devices 130.

The obtaining in this Action 201 may be understood as receiving, collecting, determining, calculating, merging, deriving, etc.

In some embodiments, the obtaining in this Action 201 may be performed in real time.

By obtaining the first mapping information in this Action 201, the first node 101 may then enable to eventually accomplish that the mapping of the space may be successfully performed.

### Action 202

In this Action 202, the first node 101 may obtain other information. The other information may indicate one or more indicators of performance of the communications system 100. The performance of the communications system 100 may be understood to refer to that which may affect transmission from the first node 101 to the second node 102, e.g., affecting the radio link between the two, or more generally, the cell 150 wherein the first node 101 may be located, and/or the network node 110 serving the first node 101.

The one or more indicators of performance may comprise at least one of: a) cell load, e.g., the load of the cell 150, b) network load, e.g., the load of the network node 110 serving the first node 101 and/or the second node 102, or the load of the neighboring cells surrounding the cell 150, c) transmission latency, and d) a quality of a radio channel used by the first node 101 for the sending 205 of the first mapping information to the second node 102, e.g., RSRQ, RSRP, SINR, which as will be described in Action 204 and Action 205, may be adapted first mapping information.

The one or more indicators of performance may be for example, KPIs. This may include, but may be not limited to, parameters such as signal strength, signal to noise and interference ratio, Channel Quality Index, (CQI), latency of the received packets, error rates, e.g., bit error rate, packet error rate and more, number of retransmissions. etc. This other information may be shared between the first node 101 and the second node 102, e.g., between the core network node 140, e.g., the server, and the plurality of devices 130, in order to dynamically control the amount of map information sent to the server and the plurality of devices 130.

The other information may be obtained by receiving the other information from e.g., another node comprised in the communications system 100, for example, a network node such as the network node 110 or a core network node such as the core network node 140. Communication KPIs available to the network may be shared with the first node 101 and the second node 102, e.g., the plurality of devices 130 and the server, in order to dynamically control the amount of map information sent to the server and the plurality of devices 130. These KPIs may be for example the load on the communication channel, resource utilization, total number of users in the cell 150, prioritization between users, etc. The network may also provide information derived from these KPIs, such as the maximum data rate available for the communication.

In some embodiments, the obtaining in this Action 202 may be performed in real time.

By obtaining the other information in this Action 202, the first node 101 may be enabled to then determine how the performance of the communications system 100 may be in the next Action 203, and in accordance with such determination, consider applying a control mechanism that may account for variations in the link throughput of the communication system, e.g., as a result from variations in channel quality, cell load, interference, etc, to regulate transmission of the first mapping information, as will be described in relation to Action 204.

### Action 203

Once the first node 101 may have obtained the other information in Action 202, the first node 101 may be able to determine how the conditions for transmission of the first mapping information may be to the second node 102, by for example, comparing the other information obtained with different criteria. In some embodiments, in this Action 203, the first node 101 may determine, based on the obtained other information, a first criterion of the performance of the communications system 100 is not met.

Determining may be understood as calculating, deriving, estimating or similar.

The first criterion may be a condition that a comparison of the average data rate with which map information may be generated with the average throughput, estimated or calculated based on the network KPIs may have to meet. The first criterion may be based on thresholds that may be applied to the comparison. For example, if the average data rate with which map information may be generated is above 70% of the average throughput, the map information may have to be adjusted to reduce the rate. Similarly, if the average data rate with which map information may be generated is below 40% of the average throughput, the resolution/size of the map information may be increased.

The “average” above may be e.g., over one second or 100 ms.

In some examples, the first criterion may be for example, that the Reference Signal Received Quality (RSRQ) is below a first threshold, or that the Reference Signal Received Power (RSRP) and the RSRQ are below a respective second threshold. In other examples, the first criterion may be: that the communication system 100 load is not below a threshold, e.g., 70% average resource utilization, or that degradation in throughput capabilities of is not below a threshold of 20%, as it is of 34%, etc.

By performing the determination in this Action 203, the first node 101 may then be enabled to know it may need to apply a control mechanism that may account for variations in the link throughput of the communication system, to regulate transmission of the first mapping information, as will be described in the next Action 204.

### Action 204

Locally mapping the environment with maximum resolution may be understood to yield the best possible representation of the environment. However, in order to fit the connectivity conditions the first node 101 may have detected in Action 203, the first node 101 may need to reduce the size of this information before transmitting it to the second node 102. Once the first node 101 may have determined that the first criterion of the performance of the communications system 100 is not met, the first node 101 may apply a control mechanism that may regulate transmission of map information, taking into account variations in e.g., link throughput.

In this Action 204, the first node 101 adapts one or more first characteristics of the first mapping information for transmission to the second node 102 operating in the communications system 100.

Adapting may be understood as e.g., changing.

The adapting in this Action 204 is based on the obtained other information.

In some embodiments, the adapting in this Action 204 may be triggered by a result of the determination performed in Action 203. The adapting in this Action 204 may comprise changing the one or more first characteristics so that one or more parameters of the transmission meet a second criterion. The second criterion may be, e.g., that a certain amount of information may be transmitted in a determined amount of time.

In some embodiments, the adapting in this Action 204 of the one or more characteristics may comprise changing at least one of: i) a rate of transmission of the first mapping information, ii) a size of the first mapping information being sent, and iii) an order of transmission of the first mapping information according to a third criterion of priority.

For example, if the available throughput is limited, the first node 101 may reduce the amount of map information transmitted over the network. This may be done by lowering the transmission rate, reducing the size of the transmitted map or compressing the map instance before transmission. Similarly, if the average data rate with which map information may be generated is below a certain level of the average throughput, the amount of map information transmitted over the network may be increased.

The order in which the map instances may be transmitted may be adjusted based on importance. The importance may be determined both by the difference between map instances, how much new data each map instance may be going to contain, or by situational awareness, such as the detection of objects or humans. The term “difference between map instances”, may be understood to define either the difference between consecutive map instances or the difference between map instances that may refer to the same captured area and may be acquired by other agents. Further, difference between map instances may describe also map instances acquired by the same agent in different time points.

The amount of map information that may be transmitted may also be limited due to prioritization of other data, such as control data. Quality of Service (QoS) functionality in 5G may be used to ensure that the map information may obtain the right priority in relation to other types of data.

The adapting in this Action 204 is performed so that an ability of the adapted first mapping information is retained within a time constraint. The ability is to be at least one of: i) merged with second mapping information from a second space at least partially overlapping with the first space, the second mapping information is derived from the one or more second sensors 142, and ii) used for localization. In other words, the first node 101 in this Action 204 may change the one or more characteristics of the first mapping information to be transmitted to the second node 102 while ensuring that the adapted transmitted first mapping information may retain its ability to be merged with mapping information that the one or more second devices 132 may have gathered in other parts of an environment wherein they may be performing their mapping mission. That is, the first mapping information may not be so heavily downsized that it may be rendered useless for the purpose of being merged with other mapping information once it reaches its destination, the second node 102, or for the purpose of localization tasks.

In some examples, several approaches may be combined, for example, the first node 101 may perform the adapting in this Action 204 by, e.g., downsampling with lossy compression, extracting representative features, and voxelization, to help the real-time transmission of the corresponding map instances.

In order to ensure that the ability of the adapted first mapping information is retained within the time constraint, the adapting may depend on the level of details in the environment. If there are many distinct features in the environment, the size of the map instances may be reduced significantly and there may still be sufficient level of detail left to merge maps or perform localization. On the other hand, if there are few details/distinct features in the environment, such as in a long corridor where most things objects may look the same, it may be more relevant to keep the details/features that may be captured, to ensure that the map may be merged or used for localization. When this is the case, the size may not be reduced further, and other adjustments to reduce the map information data rate may need to be used.

The level of detail in the map instance may be measured as an SNR.

As mentioned above, in some embodiments, the adapting in this Action 204 may comprise reducing the size of the first mapping information being sent. In some of such embodiments, the adapting in this Action 204 may be based on at least one of: a) a descriptive vector extracted from the first mapping information for use to overlap the first mapping information with the second information, b) downsampling, and c) segment-wise voxelization.

In some examples, the first node 101 may scan the environment with full resolution and save it onboard, but downsize it, e.g., with lossy compression, for transmission.

When considering the map merging problem, compressing the data by utilizing known techniques, such as downsampling the map instance, constructing supervoxels, or selecting appropriate features, e.g., geometrical, topological, or similar, to describe a region may be used to reduce the map instance information to be transmitted. Embodiments herein may be understood to aim to achieve an accurate registration between the overlapping regions, thus reducing the information up to the satisfaction of this condition. In other words, it may be understood to be important to transmit the descriptive part of the map information on time, rather than the entirety of it. Afterwards, the remaining map information that may be needed to constitute the best achievable resolution may be transmitted to increase fidelity. For example, in contrast to SLAM, where loss in fidelity is highly correlated to the accuracy of the framework, mostly localization accuracy, embodiments herein may be understood to provide a more elastic approach to the loss of fidelity and may thus enable a dynamic use of compression/adjustment in the map information to be transmitted.

The first node 101 may perform the adapting in this Action 204 by for example, adapting the size of the map instance to accommodate for the importance and/or priority of the overall transmitted information. The size of the map instance may be regulated by keeping the important information that may characterize that instance and disregard and/or dismiss the remaining unimportant information; for example, intelligent downsampling by ensuring preservation of characteristic features, e.g., corners. Different compression algorithms may define what may be considered “important information” differently and may use different methods to remove the “unimportant information”. Another aspect of the communication-aware control function may be the ability to variations in the link throughput of the communication system by regulating the size and/or frequency of the accumulated map instances.

It may be noted that the reduction techniques may be applied until the point that the map information may still be useful for the merging operation. That limit may be defined by the SNR ratio of the selected map information for transmission, where SNR may be understood to be based on the ratio of important map features/unimportant features. As important features may be characterized, all the features that may distinctively characterize the uniqueness of the space, e.g., corners, holes, unique textural information and similar. Such information may be produced by objects, corners, etc. The reordering, stitching, size reduction and in general control of these map instances may decide the newly defined map information for transmission and the one that may be used for the multiagent map merging operation.

In some examples, several approaches may be combined, for example, the first node 101 may perform the adapting in this Action 204 by size reduction, e.g., by downsampling, lossy compression, etc., rate reduction, for transmission of map instances, and reordering, to help the real-time transmission of the corresponding map instances.

In some embodiments, the adapting in this Action 204 may be performed in real time.

The adapting in this Action 204 may also be performed with the additional condition that the merging of the first mapping information with the second mapping information, once both may reach the second node 102, may need to be performed in real time. Accordingly, in some embodiments, at least one of the following options may apply. According to a first option, the time constraint may be that the ability is at least one of: i) to be merged with the second mapping information in real-time and ii) used for the localization in real time.

What may be considered “real-time” may depend on the application and the mission and may need to be configured on a use case or mission basis. An example may be that the transmission or reception of the map information, e.g., performing Action 205, 305, or 307 may take significantly less time than the duration of the mission, e.g., 10 times shorter. This may ensure that the exchange of map information may happen more often than if the local maps were to be merged through postprocessing, e.g., after the end of the mission. The definition of “real-time” may also depend on the speed with which the agents may be moving and how close the different agents may be. In principle, it may be considered to be “in time” if one agent may have obtained the right parts of a global map once it may get to a new area where the first agent may have already been.

According to a second option, the time constraint may be based on a synchronization, with the plurality of devices 130 comprising at least the first device 131 bearing the one or more first sensors 141 and the one or more second devices 132 bearing the one or more second sensors 142, to perform the merging with the second mapping information or the use for localization, for a mapping or localization mission in the space.

In order to ensure that the ability of the adapted first mapping information enables the synchronization among the plurality of devices 130, what may considered “synchronized” may depend on the application and the mission, and may need to be configured on a use case or mission basis. The definition of “synchronized” may also depend on the speed with which the agents may be moving and how close the different agents may be.

In some embodiments, the third criterion may be based on situational awareness. Using situational awareness may enable the first node 101 to decide which map instances to prioritize. The first node 101 may then perform the adapting in this Action 204 by reordering map instances. This may comprise, in some examples, identifying map instances with major changes, which may be especially useful for map updates. On multi-agent mapping conditions, the same location may be visited from multiple agents; thus, resulting in multiple map instances, that may add, or not, information for the same considered region. When every agent is synchronized, methods for identifying redundant information may be used to prevent the sharing of unnecessary data. For example, the formulation of a cost function describing the difference between similar frames may be used to reduce the transmission of redundant information.

In some embodiments, e.g., wherein Action 203 may not have been performed, the other information obtained in Action 202 may be an indication from the second node 102 to perform the adapting 204. That is, instead of the first node 101 receiving the performance data itself for analysis by the first node 101, the analysis may have been performed elsewhere, and the first node 101 may be instructed to perform the adaptation in this Action 204 by receiving the other information.

By adapting the one or more first characteristics of the first mapping information for transmission to the second node 102 in this Action 204, the first node 101 may be enabled to dynamically control the first mapping information, e.g., the size of each map instance, order of map instances, rate of map instances to transmit, based on available communication KPIs. In examples wherein the first node 101 may be the core network node 140, e.g., the server responsible for merging the mapping information from the first device 131 and the one or more second devices 132, the first node 101 may dynamically control the first mapping information for the first device 131 and the one or more second devices 132 separately.

### Action 205

In this Action 205, the first node 101 may send the adapted first mapping information to the second node 102.

In some examples, the sending in this Action 205 may be performed in the uplink. In examples wherein the first node 101 may be the first device 131, the first mapping information may be a part of a map, or map instance, created by the first device 131, transmitted to a server with the purpose of merging the maps to create one map of a larger area.

In other examples, the sending in this Action 205 may be performed in the downlink.

In examples wherein the first node 101 and the second node 102 may both be devices of the plurality of devices 130, the adapted first mapping information may be shared between the devices using sidelink.

As mentioned earlier, in some embodiments wherein the adapting in this Action 204 may be performed so that the ability of the adapted first mapping information to be used for localization may be retained. In some of such embodiments, the first mapping information may be merged mapping information derived from different sensors. In such embodiments, the sending in this Action 205 may be performed in the downlink.

In some embodiments, the sending in this Action 205 may be performed in real time.

It may be noted that the remaining mapping information, that may not have been initially selected for transmission in this Action 205, may be sent later to enhance the resolution of the global map.

By sending the adapted first mapping information to the second node 102 in this Action 205, the first node 101 may then enable usage of the first mapping information by the second node 102, so that a successful mapping mission may be ensured within the time constraint, e.g., for mapping in real time or for synchronization with other agents during a mapping mission. This may advantageously enable, for example, that an operator may have access to the merged map and awareness of the area instead of loss of a large fraction of the mapping information or extreme delays.

### Action 206

In some embodiments wherein the sending in Action 205 may be performed in the uplink, the first node 101 may, in this Action 206, obtain third mapping information from the second node 102. The third mapping information may comprise the adapted first mapping information merged with the second mapping information.

In some embodiments, the third mapping information may comprise the adapted first mapping information merged with the second mapping information. In some of such embodiments, one or more second characteristics of the second mapping information may have been separately adapted based on the other information prior to the merging with the adapted first mapping information. The one or more second characteristics may be understood to be equivalent to the one or more characteristics, but in relation to the second mapping information.

In some embodiments, the obtaining in this Action 206 may be performed in real time.

By obtaining the third mapping information in this Action 206, the first node 101 may then be enabled to plan its movements, avoid collisions with obstacles, and make more informed decisions about how to accomplish its tasks for an area/space where the first node 101 may have not yet been and therefore may not have local map information for.

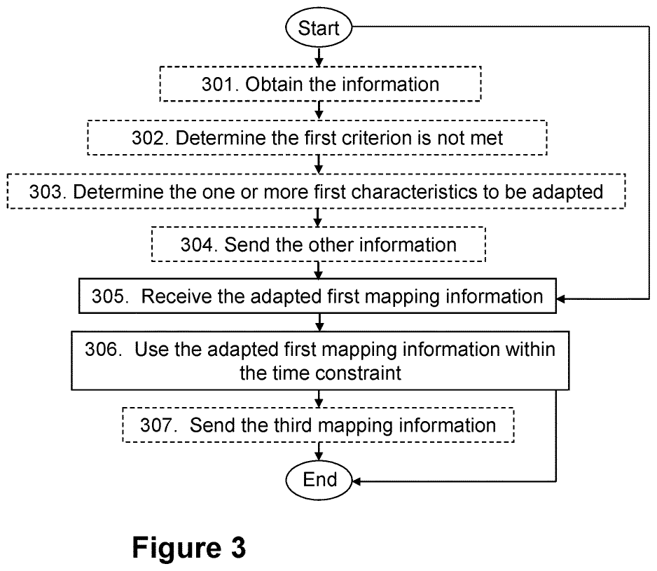

Embodiments of a computer-implemented method performed by the second node 102 will now be described with reference to the flowchart depicted in FIG. 3. The method may be understood to be for handling the mapping information enabling to map the space. The second node 102 operates in the communications system 100.

The method may comprise the following actions. In some embodiments all the actions may be performed. In some embodiments some of the actions may be performed. In FIG. 3, optional actions are indicated with a dashed box. One or more embodiments may be combined, where applicable. All possible combinations are not described to simplify the description. It should be noted that the examples herein are not mutually exclusive. Components from one example or embodiment may be tacitly assumed to be present in another example or embodiment, and it will be obvious to a person skilled in the art how those components may be used in the other examples.

The detailed description of some of the following corresponds to the same references provided above, in relation to the actions described for the first node 101 and will thus not be repeated here to simplify the description. For example, the one or more indicators of performance may be KPIs.

### Action 301

In this Action 301, the second node 102 may obtain information indicating the one or more indicators of performance of the communications system 100. This may be the same as the other information that may be obtained by the first node 101, or different information.

The obtaining in this Action 301 may be understood as receiving, determining, etc.

### Action 302

In this Action 302, the second node 102 may determine, based on the obtained information, the first criterion of the performance of the communications system 100 is not met in a similar manner described for the first node 101 in Action 203.

Determining may be understood as deriving, calculating, etc.

### Action 303

In this Action 303, the second node 102 may determine, based on a result of the determination, that the one or more first characteristics may have to be adapted so that one or more parameters of the transmission may meet the second criterion.

This Action 303 may be understood to be performed in embodiments wherein the second node 102 may decide that the adaptation of the one or more first characteristics may be necessary based on the determination performed in Action 202, and may then instruct the first node 101 to perform the adaption accordingly.

### Action 304

In this Action 304, the second node 102 may send the other information to the first node 101. The other information may comprise an indication to adapt the one or more first characteristics of the first mapping information, from the first space, derived from the one or more first sensors 141.

### Action 305

In this Action 305, the second node 102 receives, from the first node 101 operating in the communications system 100, the adapted first mapping information from the first space derived from the one or more first sensors 141. The one or more first characteristics of the first mapping information for transmission from the first node 101 are adapted so that the ability of the adapted first mapping information is retained within the time constraint. The ability is to be at least one of: i) merged with the second mapping information from the second space at least partially overlapping with the first space; the second mapping information is derived from the one or more second sensors 142, and ii) used for localization.

In some embodiments, at least one of the following may apply. According to a first option, the time constraint may be that the ability is at least one of: i) to be merged with the second mapping information in real-time, and ii) used for the localization in real time. According to a second option, the time constraint may be based on the synchronization, with the plurality of devices 130 comprising at least the first device 131 bearing the one or more first sensors 141 and the one or more second devices 132 bearing the one or more second sensors 142, to perform the merging with the second mapping information or the use for localization, for the mapping or localization mission in the space.

The adapted one or more characteristics may comprise a change at least one of: a) the rate of transmission of the first mapping information, ii) the size of the first mapping information being sent, and iii) the order of transmission of the first mapping information according to the third criterion of priority.

In some embodiments, the third criterion may be based on situational awareness.

In some embodiments, the adapted first mapping information received from the first node 101 may comprise a reduced size, and the adapted first mapping information may be based on at least one of: a) the descriptive vector extracted from the first mapping information for use to overlap the first mapping information with the second information, b) downsampling, and c) segment-wise voxalization.

In some embodiments, the first mapping information may have been adapted based on the other information indicating the one or more indicators of performance of the communications system 100, and the one or more indicators of performance may comprise at least one of: a) cell load, b) network load, c) transmission latency, and d) the quality of the radio channel used by the first node 101 for the sending 205 of the adapted first mapping information to the second node 102.

In some embodiments, the ability of the adapted first mapping information to be used for localization may be retained, the first mapping information may be merged mapping information derived from different sensors, and the receiving in this Action 305 may be performed in the downlink.

In some embodiments, the receiving in this Action 305 may be performed in the uplink.

### Action 306

In this Action 306, the second node 102 uses the received adapted first mapping information within the time constraint, based on the one or more first characteristics, to at least one of: a) merge the adapted first mapping information with the second mapping information, and b) localization. The first option may be performed in embodiments wherein the second node 102 may be the centralized server in charge of merging the mapping information, e.g., in the core network node 140 or in one of the devices of the plurality of devices 130. The second option may be performed in embodiments wherein the second node 102 may be the first device 131.

### Action 307

In some embodiments, wherein the receiving in Action 305 may be performed in the uplink, and wherein the using in Action 306 may comprise merging the adapted first mapping information with the second mapping information, in this Action 307, the second node 102 may send the third mapping information to the first node 101. The third mapping information may comprise the adapted first mapping information merged with the second mapping information.

In some embodiments, wherein the third mapping information may comprise the adapted first mapping information merged with the second mapping information, the one or more second characteristics of the second mapping information may have been separately adapted based on the other information prior to the merging with the adapted first mapping information.

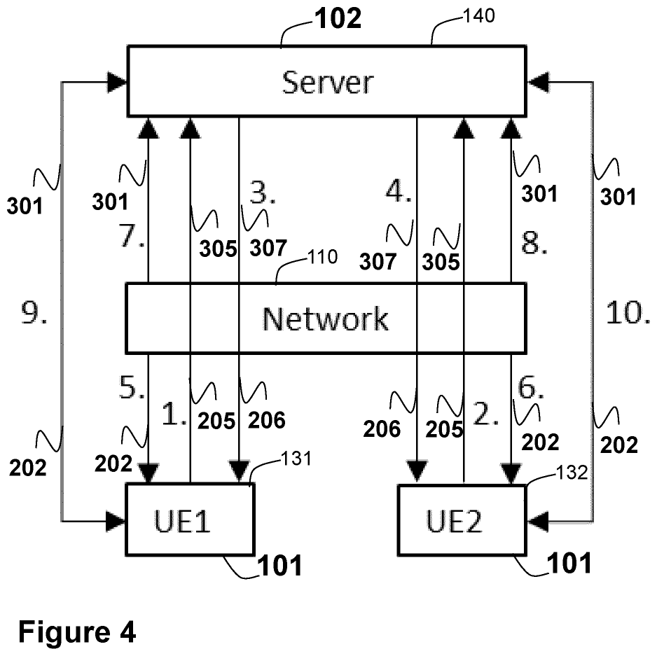

FIG. 4 is a schematic signalling diagram depicting a non-limiting example of the sequence in which the actions that may be performed by the first node 101 and the second node 102 according to embodiments herein. The prerequisites may be understood to be that there may be at least two devices, the first device 131, depicted as UE1, and a first second device 132, depicted as UE2, capable of mapping the immediate surroundings using onboard sensors, that is the one or more first sensors 141 and the one or more second sensors 142, respectively, such as e.g. lidar, cameras or other sensors, are present in an area that is to be mapped. The maps created by UE1 and UE2 may be partially overlapping. A central unit/server, in FIG. 4, the core network node 140, may be used for the merging of the maps created separately by UE1 and UE2. The central unit/server may be also responsible for distributing the merged information back to the agents. A communication network, the telecommunications network comprised in the communications system 100, may be used to transfer the maps created by UE1 and UE2 to the central unit and from the central unit back to the UEs. The communication network may be a cellular network, 4G, 5G or beyond, Wi-Fi, Bluetooth, or other technologies. The server in FIG. 4 may be implemented in a cloud 105. The server may take a decision regarding the map information to transmit in downlink but may also take a decision for the uplink. That is, the server may analyze the other information, determine how the first node 101 is to adapt the first mapping information for transmission, and instruct the first node 101 accordingly. In the particular non-limiting example of FIG. 4, both of the first device 131 and the second device 132 act as first node 101, whereas the server may be understood to be the second node 102. At 1. and 2., in accordance with Action 205, parts of the respective maps, e.g., map instances, created by UE1 and UE2 may be transmitted to the server with the purpose of merging the maps to create one map of a larger area. The respective first mapping information, e.g., size of each map instance, order of map instances, rate of map instances to transmit, may be dynamically controlled for UE1 and UE2 separately based on available communication KPIs. If the available throughput is limited, the amount of mapping information transmitted over the network may be reduced. This may be done by lowering the transmission rate, reducing the size of the transmitted map or compressing the map instance before transmission. The order in which the map instances may be transmitted may be adjusted based on importance. The importance may be determined both by the difference between map instances, e.g., how much new data may each map instance going to contain, or by situational awareness, such as the detection of objects or humans. With the term “difference between map instances”, either the difference between consecutive map instances or the difference between map instances that may refer to the same captured area and may be acquired by other agents may be defined. Further, the difference between map instances may describe also map instances acquired by the same agent in different time points. The amount of map information that may be transmitted may also be limited due to prioritization of other data, such as control data. QoS functionality in 5G may be used to ensure that the map information may get the right priority in relation to other types of data. The map instances received from UE1 and UE2 may be merged in the server and the updates of the merged map, or in certain cases the whole map, and at 3. and 4, in accordance with Action 206, may be sent back to UE1 and UE2 separately or using broadcast. The amount of map information may be dynamically controlled for UE1 and UE2 separately based on available communication KPIs. If the available throughput is limited, the amount of mapping information transmitted over the network may be reduced. This may be done by lowering the transmission rate, reducing the size of the transmitted map or compress the transmitted map. The order in which the map instances may be transmitted, or alternatively how detailed the transmitted map information may be, may be adjusted based on importance. The importance may be determined both by the difference between map instances, how much new data, or by situational awareness, such as the detection of object or humans. The amount of mapping information that may be transmitted may also be limited due to prioritization of other data, such as control data. At 5., 6., 7. and 8., communication KPIs available to the network may be shared with UE1, UE2 and the server, in agreement with Action 202, in order to dynamically control the amount of map information sent to the server and UE1 and UE2. These KPIs may be, for example, the load on the communication channel, e.g., resource utilization, total number of users in the cell 150, prioritization between users, etc. The network may also provide information derived from these KPIs, such as the maximum data rate available for the communication. At the reception of the map information at both the server and UE1 and UE2 relevant communication KPIs may be retrieved. At 9. and 10., this data may be shared between the server and UE1 and UE2 in order to dynamically control the amount of map information sent to the server and UE1 and UE2.

### EXAMPLES

A number of examples will now be provided to illustrate the embodiments herein.

### Example 1

In a first example, map instances may encompass an area on a factory floor. When the load of the communication system 100 may be above a threshold, e.g., 70% average resource utilization, as may be determined by the first node 101 in Action 202, it may be understood to be likely that the latency of the transmission increases. The first node 101 may therefore reduce, e.g., compress, down-sample or similar, the data size of each map instance in Action 204, to ensure that new information may be transmitted in Action 205 to the server and then to other agents within a specified latency limit. Note that the captured area does not necessarily decrease, meaning that the same area may be conveyed to the remaining agents.

### Example 2

A second example may be a search and rescue scenario, wherein multiple robots may be deployed to explore the area and locate any potential points of interest, such as a trapped human. In the event that one of the robots discovers a point of interest, the communication bandwidth requirements between the robots and the server may be adjusted in Action 204, to ensure that relevant information may be shared effectively. One aspect of this communication management may be understood to be the sharing of the map instances in order to replicate the common map in each robot's side, which may then allow the robots to coordinate their movements and search efforts. However, when a point of interest is discovered, the communication focus may shift to prioritize the sharing of the camera feed from the robot that made the discovery, allowing the other robots to quickly assess the situation and assist in the rescue efforts as needed. The communication bandwidth requirements may then be dynamically adjusted, that is, controlled, based on the needs of the situation, in agreement with Action 204. For example, if the point of interest is a trapped human, the camera feed from the robot that made the discovery may be given higher priority to ensure that rescuers may quickly assess the person's condition. In contrast, if the point of interest is a structural hazard, the communication focus may shift to the sharing of sensor data to assess the stability of the structure. Overall, the goal of this communication management may be understood to be to ensure that the robots may work efficiently and effectively in a coordinated manner to complete their search and rescue mission.

### Example 3

In a third example, multiple robots may be mapping a large region to perform a time sensitive inspection mission. One robot may pass through a region that may experience decreased channel conditions. The decreased channel conditions may result in a degradation in throughput capabilities of ~34%. However, it may be relevant to the mission to continuously transmit information to the centralized agent so that the mission success may be guaranteed, that is, that the operator may have access to the merged map and awareness of the area, instead of loss of a large fraction of the mapping information or extreme delays. In that case, to address this 34% deficit, the map instance data size, in agreement with Action 204, may get significantly decreased, that is, compressed, down-sampled or similar, while the transmission rate may also be dynamically decreased based on the throughput capabilities that the current channel may provide, corresponding modulation order, etc. Once the channel conditions/quality restores, and the link throughput is restored, the adaptation of the map information may also be restored to ensure that map information with as high resolution as possible may be available at the centralized agent and the operator. Restoring the adaptation may e.g., include increasing the transmission rate and stop performing lossy compression or downsampling.

### Example 4

In a fourth example, multiple robots may be mapping a large region. As one robot may enter an area where its communication gets degraded, then it may have to, in agreement with Action 204, dynamically adjust the transmission of map information to fit the communication capabilities. Degraded communication may occur from e.g., bad channel conditions, increased network load, or increased cell load. The map information/instance to be transmitted from each robot may be downsampled so that only the important features may be preserved, e.g., edge features, semantic features and so on. The previous operation may be accompanied with the dynamic reduction of data rate transmission. The selected adjusted map instances may then reach the centralized unit, e.g., the edge server and the map merging operation may be performed, the distribution of the remaining information back to the agents may subsequently be performed in agreement with Action 206, as previously described. When the communication conditions are restored, the additional high-resolution information may be communicated in order to fill in the remaining map information. Finally, a full capture of all the local maps may be communicated across all the entities, to better values, so that higher resolution may then become available.

### Example 5

In a fifth example, multiple agents may be mapping an area. An agent may create its own local map and at the same time may seek to transmit that mapping information to the edge server/centralized unit. To do so, it may monitors the important indicators that may characterize the performance of the network and the expected average network throughput. These factors may be the observed by channel conditions, characterized by radio signaling KPIs, such as SINR, RSRQ, RSRP, network and cell load, and similar. In some situations, the data rate that may be transmitted over the network may decrease. This may happen if the channel quality, measured e.g., by RSRP, may become worse, if the interference, e.g., due to increased load in neighboring cells, may increase, or if the load in the serving cell may be increased, so that less resources may be available for transmissions over the network between the agent and the central unit. If the agent is generating more map information than what may be transmitted over the network, a queue may start to build up in a buffer on the agent/robot side. This may happen if the resolution of the map information is too high to be transmitted over the network or if the data rate that may be transmitted over the network decreases. Note that buffered data may result in increased latency and may even cause randomly dropped packets, when data may exceed the buffer capacity. To cope with that, the agent may monitor the aforesaid KPIs and similar, and may initiate the control mechanism described in Action 204. More specifically, data/map information selected for transmission may be decreased up to the point that data may not be accumulated in the transmission buffers. Transient behaviors may be permitted, but the overall behavior may be required to express a constant data flow, thus no data accumulation. The control mechanism, or adaption mechanism, may comprise several actions. The actions listed here may be applied in any order and/or combination. The first action may refer to the reduction of the data size of the map information to be transmitted. To do that, several techniques may be applied as described in Action 204, such as: 1) reduction of the map information by downsampling/filtering map information, which may be understood to reduce the size, 2) segment wise voxelization, here regions of the map information may be grouped together and represent a bigger volume of space, again reducing the size, 3) combing adjacent map information and dropping “duplicate” areas may be applied to result in less size. A second action may be to adjust the rate with which map information may be transmitted in Action 205. If the movement of the agent is slow, some of the map instances, e.g., generated by a SLAM algorithm, may be discarded. It may be understood to be relevant to keep a sufficient number of map instances, so that there may still be an overlap between them, so that they may be merged. A third action may be to reorder the map instances according to a priority based on situational awareness. The remaining map information, that may not have been initially selected, may be sent later to enhance the resolution of the global map.

As a summarized overview of the foregoing, embodiments herein may be understood to enable to use information about the communication network KPIs and channel to control the transmission of map instances in a real-time, multi-agent map-merging scheme. Embodiments herein may therefore be understood to relate to the dynamic control of mapping information transmission based on communication KPIs. In some examples, the mapping information transmission may be specified by the rate of transmitted map instances. In some examples, the communication KPI may be the load on the communication channel, e.g., resource utilization. In some examples, the communication KPI may be the transmission latency. In some examples, the data size of the mapping information may be adjusted, for example by adjusting the resolution, to the communication KPIs. In some examples, the map instances may be reordered according to importance. Importance may be be based on differences between map instances. In some examples, the importance of a map instance may be based on situational awareness. In some examples, it may be important to consider the case where there may be critical data to transmit as well, e.g., control of a robot. The control of mapping information may be performed separately in the uplink and the downlink.

Certain embodiments disclosed herein may provide one or more of the following technical advantage(s), which may be summarized as follows. One advantage of embodiments herein may be understood to be that embodiments herein may maintains the robustness of a real-time map merging between two agents in situations with changing network properties by adjusting/controlling the produced map information transmitted over the network. This ensures that the merged map contains the latest available information and that the agents receive the latest available updates of the map during the mission.

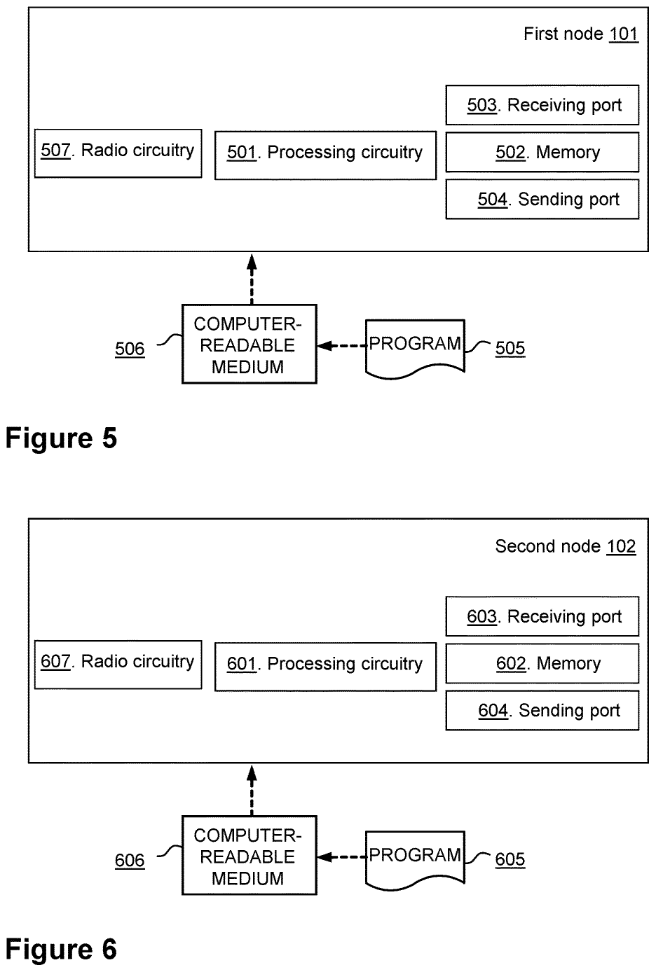

FIG. 5 depicts an example of the arrangement that the first node 101 may comprise to perform the method described in FIG. 2 and/or FIG. 4. The first node 101 may be understood to be for handling the mapping information enabling to map the space. The first node 101 is configured to operate in the communications system 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the first node 101 and will thus not be repeated here. For example, the one or more indicators of performance may be configured to be KPIs.

The first node 101 is configured to obtain the mapping information from the first space configured to be derived from the one or more first sensors 141.

The first node 101 is also configured to obtain the other information configured to indicate the one or more indicators of performance of the communications system 100.

The first node 101 is further configured to adapt the one or more first characteristics of the first mapping information for transmission to the second node 102 configured to operate in the communications system 100. The adapting is configured to be based on the other information configured to be obtained. The adapting is configured to be performed so that the ability of the adapted first mapping information is retained within the time constraint. The ability is configured to be, to be at least one of: i) merged with is second mapping information from is second space at least partially overlapping with the first space, the second mapping information being configured to be derived from is one or more second sensors 142, and ii) used for localization.

The first node 101 is additionally configured to send the first mapping information configured to be adapted to the second node 102.

In some embodiments, at least one of the following may apply. According to a first option, the time constraint may be configured to be that the ability may be at least one of: i) to be merged with the second mapping information in real-time and ii) used for the localization in real time. According to a second option, the time constraint may be configured to be based on the synchronization with the plurality of devices 130. The plurality of devices 130 may comprise at least the first device 131 configured to be bearing the one or more first sensors 141 and the one or more second devices 132 configured to be bearing the one or more second sensors 142. The synchronization with the plurality of devices 130 may be to perform the merging with the second mapping information or the use for localization, for the mapping or localization mission in the space.

In some embodiments, at least one of the following may apply. According to a first option, the first node 101 is further configured to determine, based on the other information configured to be obtained, the first criterion of the performance of the communications system 100 is not met. The adapting configured to be triggered by the result of the determination, and the adapting may be configured to comprise changing the one or more first characteristics so that one or more parameters of the transmission meet a second criterion. According to a second option, the other information may be configured to be the indication from the second node 102 to perform the adapting 204.

In some embodiments, the adapting of the one or more characteristics may be configured to comprise changing at least one of: i) the rate of transmission of the first mapping information, ii) the size of the first mapping information being sent, and iii) the order of transmission of the first mapping information according to the third criterion of priority.

The third criterion may be configured to be based on situational awareness.

In some embodiments, wherein the adapting may be configured to comprise reducing the size of the first mapping information configured to be sent, the adapting may be configured to be based on at least one of: a) the descriptive vector configured to be extracted from the first mapping information for use to overlap the first mapping information with the second information, b) downsampling, and c) segment-wise voxelization.

In some embodiments, the one or more indicators of performance may be configured to comprise at least one of: a) cell load, b) network load, c) transmission latency, and d) the quality of the radio channel used by the first node 101 for the sending of the adapted first mapping information to the second node 102.

In some embodiments, wherein the adapting may be configured to be performed so that the ability of the adapted first mapping information to be used for localization may be retained, the first mapping information may be configured to be merged mapping information derived from different sensors, and the sending may be configured to be performed in the downlink.

In some embodiments wherein the sending may be configured to be performed in the uplink, the first node 101 may be further configured to obtain the third mapping information from the second node 102. The third mapping information may be configured to comprise the adapted first mapping information merged with the second mapping information.

In some embodiments, wherein the third mapping information may be configured to comprise the adapted first mapping information merged with the second mapping information, the one or more second characteristics of the second mapping information may be configured to have been separately adapted based on the other information prior to the merging with the adapted first mapping information.

The embodiments herein in the first node 101 may be implemented through one or more processors, such as a processing circuitry 501 in the first node 101 depicted in FIG. 5, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first node 101. One such carrier may be in the form of a CD ROM disc. It is however feasible with other data carriers such as a memory stick. The computer program code may furthermore be provided as pure program code on a server and downloaded to the first node 101.

The first node 101 may further comprise a memory 502 comprising one or more memory units. The memory 502 is arranged to be used to store obtained information, store data, configurations, schedulings, and applications etc. to perform the methods herein when being executed in the first node 101.

In some embodiments, the first node 101 may receive information from, e.g., the second node 102, the first device 131, the one or more second devices 132, the network node 110, the core network node 140, any of the devices in the plurality of devices 130, another node, and/or another structure in the communications system 100, through a receiving port 503. In some embodiments, the receiving port 503 may be, for example, connected to one or more antennas in first node 101. In other embodiments, the first node 101 may receive information from another structure in the communications system 100 through the receiving port 503. Since the receiving port 503 may be in communication with the processing circuitry 501, the receiving port 503 may then send the received information to the processing circuitry 501. The receiving port 503 may also be configured to receive other information.

The processing circuitry 501 in the first node 101 may be further configured to transmit or send information to e.g., the second node 102, the first device 131, the one or more second devices 132, the network node 110, the core network node 140, any of the devices in the plurality of devices 130, another node, and/or another structure in the communications system 100, through a sending port 504, which may be in communication with the processing circuitry 501, and the memory 502.

Those skilled in the art will also appreciate that the units comprised within the first node 101 described above as being configured to perform different actions, may refer to a combination of analog and digital circuits, and/or one or more processors configured with software and/or firmware, e.g., stored in memory, that, when executed by the one or more processors such as the processing circuitry 501, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units comprised within the first node 101 described above as being configured to perform different actions described above may be implemented as one or more applications running on one or more processors such as the processing circuitry 501.

Thus, the methods according to the embodiments described herein for the first node 101 may be respectively implemented by means of a computer program 505 product, comprising instructions, i.e., software code portions, which, when executed on at least one processing circuitry 501, cause the at least one processing circuitry 501 to carry out the actions described herein, as performed by the first node 101. The computer program 505 product may be stored on a computer-readable storage medium 506. The computer-readable storage medium 506, having stored thereon the computer program 505, may comprise instructions which, when executed on at least one processing circuitry 501, cause the at least one processing circuitry 501 to carry out the actions described herein, as performed by the first node 101. In some embodiments, the computer-readable storage medium 506 may be a non-transitory computer-readable storage medium, such as a CD ROM disc, or a memory stick. In other embodiments, the computer program 505 product may be stored on a carrier containing the computer program 505 just described, wherein the carrier is one of an electronic signal, optical signal, radio signal, or the computer-readable storage medium 506, as described above.

The first node 101 may comprise a communication interface configured to facilitate, or an interface unit to facilitate, communications between the first node 101 and other nodes or devices, e.g., the second node 102, the first device 131, the one or more second devices 132, the network node 110, the core network node 140, any of the devices in the plurality of devices 130, another node, and/or another structure in the communications system 100. The interface may, for example, include a transceiver configured to transmit and receive radio signals over an air interface in accordance with a suitable standard.

In other embodiments, the first node 101 may comprise a radio circuitry 507, which may comprise e.g., the receiving port 503 and the sending port 504.

The radio circuitry 507 may be configured to set up and maintain at least a wireless connection with the second node 102, the first device 131, the one or more second devices 132, the network node 110, the core network node 140, any of the devices in the plurality of devices 130, another node, and/or another structure in the communications system 100. Circuitry may be understood herein as a hardware component.

Hence, embodiments herein also relate to the first node 101 operative to operate in the communications system 100. The first node 101 may comprise the processing circuitry 501 and the memory 502, said memory 502 containing instructions executable by said processing circuitry 501, whereby the first node 101 is further operative to perform the actions described herein in relation to the first node 101, e.g., in FIG. 2 and/or FIG. 4.

FIG. 6 depicts an example of the arrangement that the second node 102 may comprise to perform the method described in FIG. 3 and/or FIG. 4. The second node 102 may be understood to be for handling the mapping information enabling to map the space. The second node 102 is configured to operate in the communications system 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the second node 101 and will thus not be repeated here. The detailed description of some of the following corresponds to the same references provided above, in relation to the actions described for the first node 101 and will thus not be repeated here. For example, the one or more indicators of performance may be configured to be KPIs.

The second node 102 is configured to receive, from the first node 101 configured to operate in the communications system 100, the adapted first mapping information from the first space configured to be derived from the one or more first sensors 141. The one or more first characteristics of the first mapping information for transmission from the first node 101 are configured to be adapted so that the ability of the adapted first mapping information is retained within the time constraint. The ability is configured to be, to be at least one of: i) merged with the second mapping information from the second space at least partially overlapping with the first space, the second mapping information being configured to be derived from the one or more second sensors 142, and ii) used for localization.

The second node 102 is also configured to use the adapted first mapping information configured to be received within the time constraint, based on the one or more first characteristics, to at least one of: a) merge the adapted first mapping information with the second mapping information, and b) localization.

In some embodiments, at least one of the following may apply. According to a first option, the time constraint may be configured to be that the ability may be at least one of: i) to be merged with the second mapping information in real-time and ii) used for the localization in real time. According to a second option, the time constraint may be configured to be based on the synchronization with the plurality of devices 130. The plurality of devices 130 may comprise at least the first device 131 configured to be bearing the one or more first sensors 141 and the one or more second devices 132 configured to be bearing the one or more second sensors 142. The synchronization with the plurality of devices 130 may be to perform the merging with the second mapping information or the use for localization, for the mapping or localization mission in the space.

In some embodiments, the adapted one or more characteristics may be configured to comprise the change in at least one of: i) the rate of transmission of the first mapping information, ii) the size of the first mapping information being sent, and iii) the order of transmission of the first mapping information according to the third criterion of priority.

The third criterion may be configured to be based on situational awareness.

In some embodiments, wherein the adapted first mapping information configured to be sent by the first node 101 may be configured to comprise the reduced size, the adapting may be configured to be based on at least one of: a) the descriptive vector configured to be extracted from the first mapping information for use to overlap the first mapping information with the second information, b) downsampling, and c) segment-wise voxelization.

In some embodiments wherein the first mapping information may be configured to have been adapted based on the other information configured to indicate the one or more indicators of performance of the communications system 100, the one or more indicators of performance may be configured to comprise at least one of: a) cell load, b) network load, c) transmission latency, and d) the quality of the radio channel used by the first node 101 for the sending of the adapted first mapping information to the second node 102.

In some embodiments, wherein the ability of the adapted first mapping information to be used for localization may be configured to be retained, the first mapping information may be configured to be merged mapping information derived from different sensors, and the receiving may be configured to be performed in the downlink.

In some embodiments, the second node 102 may be further configured to at least one of the following. According to a first option, obtain the information configured to indicate the one or more indicators of performance of the communications system 100. According to a second option, determine, based on the information configured to be obtained, the first criterion of the performance of the communications system 100 is not met. According to a third option, determine, based on a result of the determination, that the one or more first characteristics may have to be adapted so that the one or more parameters of the transmission meet the second criterion. According to a fourth option, send the other information to the first node 101. The other information may be configured to comprise the indication to adapt the one or more first characteristics of first mapping information from the first space derived from the one or more first sensors 141.

In some embodiments wherein the receiving may be configured to be performed in the uplink, the second node 102 and wherein the using may be configured to comprise merging the adapted first mapping information with the second mapping information, the second node 102 may be further configured to send the third mapping information to the first node 101. The third mapping information may be configured to comprise the adapted first mapping information merged with the second mapping information.

In some embodiments, wherein the third mapping information may be configured to comprise the adapted first mapping information merged with the second mapping information, the one or more second characteristics of the second mapping information may be configured to have been separately adapted based on the other information prior to the merging with the adapted first mapping information.

The embodiments herein in the second node 102 may be implemented through one or more processors, such as a processing circuitry 601 in the second node 102 depicted in FIG. 6, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the second node 102. One such carrier may be in the form of a CD ROM disc. It is however feasible with other data carriers such as a memory stick. The computer program code may furthermore be provided as pure program code on a server and downloaded to the second node 102.

The second node 102 may further comprise a memory 602 comprising one or more memory units. The memory 602 is arranged to be used to store obtained information, store data, configurations, schedulings, and applications etc. to perform the methods herein when being executed in the second node 102.

In some embodiments, the second node 102 may receive information from, e.g., the first node 101, the first device 131, the one or more second devices 132, the network node 110, the core network node 140, any of the devices in the plurality of devices 130, another node, and/or another structure in the communications system 100, through a receiving port 603. In some embodiments, the receiving port 603 may be, for example, connected to one or more antennas in second node 102. In other embodiments, the second node 102 may receive information from another structure in the communications system 100 through the receiving port 603. Since the receiving port 603 may be in communication with the processing circuitry 601, the receiving port 603 may then send the received information to the processing circuitry 601. The receiving port 603 may also be configured to receive other information.

The processing circuitry 601 in the second node 102 may be further configured to transmit or send information to e.g., the first node 101, the first device 131, the one or more second devices 132, the network node 110, the core network node 140, any of the devices in the plurality of devices 130, another node, and/or another structure in the communications system 100, through a sending port 604, which may be in communication with the processing circuitry 601, and the memory 602.

Those skilled in the art will also appreciate that the units comprised within the second node 102 described above as being configured to perform different actions, may refer to a combination of analog and digital circuits, and/or one or more processors configured with software and/or firmware, e.g., stored in memory, that, when executed by the one or more processors such as the processing circuitry 601, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units comprised within the second node 102 described above as being configured to perform different actions described above may be implemented as one or more applications running on one or more processors such as the processing circuitry 601.

Thus, the methods according to the embodiments described herein for the second node 102 may be respectively implemented by means of a computer program 605 product, comprising instructions, i.e., software code portions, which, when executed on at least one processing circuitry 601, cause the at least one processing circuitry 601 to carry out the actions described herein, as performed by the second node 102. The computer program 605 product may be stored on a computer-readable storage medium 606. The computer-readable storage medium 606, having stored thereon the computer program 605, may comprise instructions which, when executed on at least one processing circuitry 601, cause the at least one processing circuitry 601 to carry out the actions described herein, as performed by the second node 102. In some embodiments, the computer-readable storage medium 606 may be a non-transitory computer-readable storage medium, such as a CD ROM disc, or a memory stick. In other embodiments, the computer program 605 product may be stored on a carrier containing the computer program 605 just described, wherein the carrier is one of an electronic signal, optical signal, radio signal, or the computer-readable storage medium 606, as described above.

The second node 102 may comprise a communication interface configured to facilitate, or an interface unit to facilitate, communications between the second node 102 and other nodes or devices, e.g., the first node 101, the first device 131, the one or more second devices 132, the network node 110, the core network node 140, any of the devices in the plurality of devices 130, another node, and/or another structure in the communications system 100. The interface may, for example, include a transceiver configured to transmit and receive radio signals over an air interface in accordance with a suitable standard.

In other embodiments, the second node 102 may comprise a radio circuitry 607, which may comprise e.g., the receiving port 603 and the sending port 604.

The radio circuitry 607 may be configured to set up and maintain at least a wireless connection with the first node 101, the first device 131, the one or more second devices 132, the network node 110, the core network node 140, any of the devices in the plurality of devices 130, another node, and/or another structure in the communications system 100. Circuitry may be understood herein as a hardware component.

Hence, embodiments herein also relate to the second node 102, operative to operate in the communications system 100. The second node 102 may comprise the processing circuitry 601 and the memory 602, said memory 602 containing instructions executable by said processing circuitry 601, whereby the second node 102 is further operative to perform the actions described herein in relation to the second node 102, e.g., in FIG. 3 and/or FIG. 4.

When using the word “comprise” or “comprising”, it shall be interpreted as non-limiting, i.e., meaning “consist at least of”.

The embodiments herein are not limited to the above described preferred embodiments. Various alternatives, modifications and equivalents may be used. Therefore, the above embodiments should not be taken as limiting the scope of the invention.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

Any of the terms processor and circuitry may be understood herein as a hardware component.

As used herein, the expression “in some embodiments” has been used to indicate that the features of the embodiment described may be combined with any other embodiment or example disclosed herein.

As used herein, the expression “in some examples” has been used to indicate that the features of the example described may be combined with any other embodiment or example disclosed herein.

### REFERENCES

1. T. M. Bonanni, B. Della Corte and G. Grisetti, “3-D Map Merging on Pose Graphs,” in IEEE Robotics and Automation Letters, vol. 2, no. 2, pp. 1031-1038, April 2017, doi: 10.1109/LRA.2017.2655139.
2. P. Dinnissen, S. N. Givigi and H. M. Schwartz, “Map merging of Multi-Robot SLAM using Reinforcement Learning,” 2012 IEEE International Conference on Systems, Man, and Cybernetics (SMC), Seoul, Korea (South), 2012, pp. 53-60, doi: 10.1109/ICSMC.2012.6377676.

1.-44. (canceled)

45. A method performed by a first node, the method being for handling mapping information enabling to map a space, the first node operating in a communications system, the method comprising:
obtaining first mapping information from a first space derived from one or more first sensors;
obtaining information indicating of performance of the communications system;
adapting one or more first characteristics of the first mapping information for transmission to a second node operating in the communications system, the adapting being based on the obtained performance information to enable real-time transmission of the adapted first mapping information to the second node so as to merge with second mapping information from a second space which is at least partially overlapping with the first space; and
sending the adapted first mapping information to the second node.

46. The method according to claim 45, further comprising:
determining, based on the obtained performance information, a first criterion of the performance of the communications system is not met, wherein the adapting is triggered by a result of the determination, and wherein the adapting comprises changing one or more first characteristics so that the real-time transmission meet a second criterion.

47. The method according to claim 46, wherein the adapting of the one or more characteristics comprises changing at least one of:
a rate of transmission of the first mapping information;
a size of the first mapping information being sent; and
an order of transmission of the first mapping information according to a third criterion of priority.

48. The method according to claim 45, wherein the information of performance comprises at least one of:
cell load;
network load;
transmission latency; and
a quality of a radio channel used by the first node for the sending of the adapted first mapping information to the second node.

49. The method according to claim 45, wherein the adapting of the one or more characteristics comprises changing at least one of:
a rate of transmission of the first mapping information;
a size of the first mapping information being sent; and
an order of transmission of the first mapping information according to a third criterion of priority.

50. The method according to claim 49, wherein the adapting comprises reducing the size of the first mapping information being sent, and wherein the adapting is performed based on at least one of:
a descriptive vector extracted from the first mapping information for use to overlap the first mapping information with the second information;
downsampling; and
segment-wise voxelization.

51. The method according to claim 45, wherein the information of performance comprises at least one of:
cell load;
network load;
transmission latency; and
a quality of a radio channel used by the first node for the sending of the adapted first mapping information to the second node.

52. The method according to claim 45, wherein the sending is performed in uplink direction, and wherein the method further comprises:
obtaining third mapping information from the second node, the third mapping information comprising the adapted first mapping information merged with the second mapping information.

53. A method performed by a second node, the method being for handling mapping information enabling to map a space, the second node operating in a communications system, the method comprising:
receiving, from a first node operating in the communications system, adapted first mapping information from a first space derived from one or more first sensors, the adapted first mapping information having been adapted at least partly according to performance information of the communication system;
receiving second mapping information from a second space derived from one or more second sensors, wherein the second space overlaps at least partly with the first space; and
merging the adapted first mapping information with the second mapping information in a real-time manner.

54. The method according to claim 53, further comprising:
obtaining the performance information of the communications system;
determining, based on the obtained performance information, a first criterion of the performance of the communications system is not met;
determining, based on a result of the determination, that one or more first characteristics of original first mapping information are to be adapted so that one or more parameters of the transmission meet a second criterion; and
sending, to the first node, an indication to adapt the one or more first characteristics.

55. The method according to claim 54, wherein the obtained performance information comprises at least one of:
cell load;
network load;
transmission latency; and
a quality of a radio channel used by the first node for the sending of the adapted first mapping information to the second node.

56. The method according to claim 54, wherein the indication comprises at least one of the following characteristics to be adapted:
a rate of transmission of the first mapping information;
a size of the first mapping information being sent; and
an order of transmission of the first mapping information according to a third criterion of priority.

57. The method according to claim 53, further comprising:
sending third mapping information to the first node, the third mapping information comprising merged mapping information between the adapted first mapping information and the second mapping information.

58. The method according to claim 57, wherein one or more second characteristics of the second mapping information have been separately adapted prior to obtained by the second node.

59. A first node, for handling mapping information enabling to map a space, the first node being configured to operate in a communications system, the first node being further configured to:
obtain first mapping information from a first space derived from one or more first sensors;
obtain information indicating of performance of the communications system;
adapt one or more first characteristics of the first mapping information for transmission to a second node operating in the communications system, the adapting being based on the obtained performance information to enable real-time transmission of the adapted first mapping information to the second node so as to merge with second mapping information from a second space which is at least partially overlapping with the first space; and
send the adapted first mapping information to the second node.

60. The first node according to claim 59, further configured to:
determine, based on the obtained performance information, a first criterion of the performance of the communications system is not met, wherein the adapting is triggered by a result of the determination, and wherein the adapting comprises changing one or more first characteristics so that the real-time transmission meet a second criterion.

61. The first node according to claim 59, wherein the adapting of the one or more characteristics comprises changing at least one of:
a rate of transmission of the first mapping information;
a size of the first mapping information being sent; and
an order of transmission of the first mapping information according to a third criterion of priority.

62. The first node according to claim 61, wherein the adapting comprises reducing the size of the first mapping information being sent, and wherein the adapting is performed based on at least one of:
a descriptive vector extracted from the first mapping information for use to overlap the first mapping information with the second information;
downsampling; and
segment-wise voxelization.

63. The first node according to claim 59, wherein the information of performance comprises at least one of:
cell load;
network load;
transmission latency; and
a quality of a radio channel used by the first node for the sending of the adapted first mapping information to the second node.

64. The first node according to claim 59, wherein the sending is performed in uplink direction, and wherein the first node is further configured to:
obtain third mapping information from the second node, the third mapping information comprising the adapted first mapping information merged with the second mapping information.
